(19) United States
(12) Patent Application Publication
(10) Pub. No.: US 2013/0249802 A1
(43) Pub. Date: Sep. 26, 2013

(54) TOUCH KEYBOARD

(71) Applicant: PRIMAX ELECTRONICS LTD., Neihu (TW)

(72) Inventor: Taizo Yasutake, Cupertino, CA (US)

(73) Assignee: Primax Electronics Ltd., Neihu (TW)

(21) Appl. No.: 13/753,955

(22) Filed: Jan. 30, 2013

Related U.S. Application Data
(60) Provisional application No. 61/614,753, filed on Mar. 23, 2012.

(51) Int. Cl. G06F 3/02

(52) U.S. Cl. CPC G06F 3/02
USPC 345/168

(57) ABSTRACT

A touch keyboard includes an overlay frame, a touch pad, and a feedback device. The touch pad and the feedback device are disposed under the overlay frame. The overlay frame has plural openings for providing the keystrokes of the touch keyboard. When the user's finger is penetrated through a corresponding opening to touch the touch pad, the touch pad generates a key signal, and the feedback device generates a feedback signal to the user. The touch keyboard is thin and lightweight, and is easily carried. Moreover, due to the keystrokes provided by the overlay frame and the feedback device, the touch keyboard is more user-friendly.

### CROSS-REFERENCE TO RELATED APPLICATION

This application claims priority to U.S. Provisional Patent Application No. 61/614,753 entitled “Multi-Touch Sensor based Keyboard with Multi-Modal Touch Feedback Functions” filed Mar. 23, 2012, the contents of which are incorporated herein by reference.

### FIELD OF THE INVENTION

The present invention relates to a keyboard, and more particularly to a touch keyboard.

### BACKGROUND OF THE INVENTION

Recently, the multi-touch input technology applied to a tablet computer has been introduced to a virtual keyboard or a touch keyboard in a personal computer market. However, due to the lack of the tactile feedback under the environment of the virtual keyboard, the key touch feel of the virtual keyboard is usually insufficient. In other words, the virtual keyboard fails to provide a user-friendly interface. For solving the above drawbacks, when a tablet computer is used to do paperwork or other typing work, the tablet computer is usually equipped with an additional standard keyboard (e.g. a keyboard with mechanical keys).

The additional standard keyboard for the tablet computer is similar to the conventional keyboard. For example, the additional standard keyboard is thick and has bulky hardware components. Because of hardware design properties of the conventional keyboard, many users pointed out that the current keyboard is not suitably placed within the carrying case of the tablet computer. Under this circumstance, it is troublesome to carry the keyboard for the tablet computer.

Therefore, there is a need of providing a thin and lightweight keyboard for a tablet computer.

### SUMMARY OF THE INVENTION

The present invention provides a thin touch keyboard.

In accordance with an aspect of the present invention, there is provided a touch keyboard. The touch keyboard includes an overlay frame, a touch pad, and a feedback device. The overlay frame includes plural openings. The touch pad is disposed under the overlay frame. When the touch pad is touched through one of the plural openings, the touch pad generates a key signal. The feedback device is disposed under the overlay frame for generating a feedback signal in response to the key signal.

In an embodiment, the touch pad is disposed over the feedback device.

In an embodiment, the touch pad is disposed under the feedback device.

In an embodiment, the touch pad is a capacitive touch pad or a resistive touch pad.

In an embodiment, the feedback device is a piezo actuator.

In an embodiment, the feedback device further includes a speaker.

In an embodiment, the feedback device includes a feedback region.

In an embodiment, the feedback device includes plural feedback regions.

In an embodiment, the plural feedback regions are arranged along a horizontal direction.

In an embodiment, the plural feedback regions are arranged along a vertical direction.

In an embodiment, each of the plural feedback regions has a short side and a long hypotenuse, wherein an included angle is formed between the short side and the long hypotenuse.

In an embodiment, every two openings are separated from each other by a notch.

In an embodiment, the overlay frame further includes plural non-conductive slices. Each opening has an inner wall. Moreover, each of the non-conductive slices is disposed on the inner wall of the corresponding opening.

In an embodiment, the non-conductive slices are elastic rings.

In an embodiment, the touch keyboard includes a non-conductive plate, and the non-conductive plate is disposed under the overlay frame. The non-conductive plate includes plural perforations and plural bulges. Each of the plural perforation has an inner wall, and each of the plural bulges is disposed on the inner wall of the corresponding perforation. The plural perforations are aligned with the plural openings of the overlay frame, respectively.

In an embodiment, the overlay frame is made of a non-conductive material.

In an embodiment, the plural openings of the overlay frame are rectangular openings or circular openings.

In an embodiment, the touch keyboard further includes a base plate, and the base plate is disposed under the touch pad and the feedback device. The base plate includes a sliding groove, and the sliding groove is disposed on a lateral edge of the base plate for accommodating the overlay frame.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a touch keyboard according to a first embodiment of the present invention;

FIG. 2A is a schematic exploded view illustrating a touch keyboard according to a second embodiment of the present invention;

FIG. 2B is a schematic cross-sectional view illustrating the touch keyboard according to the second embodiment of the present invention;

FIG. 3 is a schematic partial perspective view illustrating an overlay frame of a touch keyboard according to a third embodiment of the present invention;

FIG. 4A is a schematic partial perspective view illustrating an overlay frame of a touch keyboard according to a fourth embodiment of the present invention;

FIG. 4B is a schematic cross-sectional view illustrating the touch keyboard according to the fourth embodiment of the present invention;

FIG. 5A is a schematic partial perspective view illustrating an overlay frame of a touch keyboard according to a fifth embodiment of the present invention;

FIG. 5B is a schematic top view illustrating a ring-shaped non-conductive slice of the touch keyboard of FIG. 5A;

FIGS. 5C-5E are schematic top views illustrating some variants of the ring-shaped non-conductive slice of the touch keyboard of FIG. 5A;

FIG. 5F is a schematic exploded view illustrating a touch keyboard according to a sixth embodiment of the present invention;

FIGS. 6A and 6B schematically illustrate the actions of a piezo actuator used in the touch keyboard of the present invention;

FIG. 7 schematically illustrates the layout of a US standard keyboard;

FIG. 8 is a schematic top view illustrating the feedback regions of a feedback device of a touch keyboard according to a seventh embodiment of the present invention;

FIGS. 9A-9D are schematic top views illustrating some variants of the feedback regions of the feedback device used in the touch keyboard of the present invention;

FIG. 9E is a schematic exploded view illustrating a touch keyboard according to an eighth embodiment of the present invention;

FIG. 10 is a schematic top view illustrating a touch keyboard according to a ninth embodiment of the present invention; and

FIG. 11 is a schematic functional block illustrating a touch keyboard according to a tenth embodiment of the present invention.

### DETAILED DESCRIPTION OF THE PREFERRED EMBODIMENT

### Multi-Modal Touch Feedback Generation by Overlay Frame and Piezo Actuator

The present invention provides a novel keyboard design. The keyboard of the present invention is a thin and lightweight touch keyboard with multi-modal touch feedback. The touch keyboard provides plural touch feedback mechanisms for correctly generating keystrokes. The hardware components of the touch keyboard comprises (i) a touch pad such as a multi-touch pad (e.g. a capacitive touch pad or a resistive touch pad); and (ii) a feedback device (e.g. a piezo actuator) disposed under or over the touch pad for generating mechanical vibration on the surface of the touch pad; and (iii) an overlay frame disposed over the touch pad for providing a tactile feedback to the user's fingertip.

### Hardware Structure and its Usage

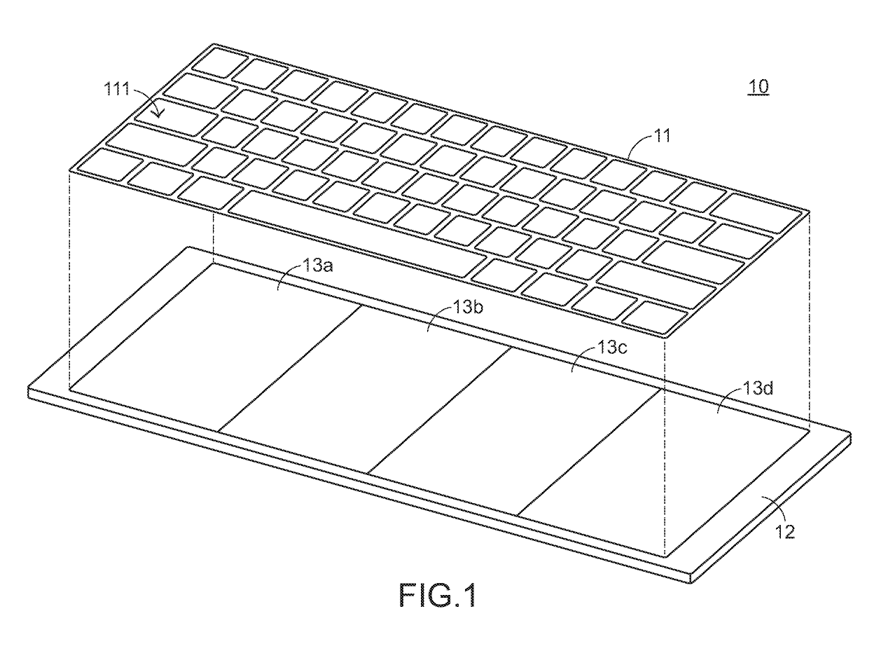

FIG. 1 is a schematic perspective view illustrating a touch keyboard according to a first embodiment of the present invention. As shown in FIG. 1, the touch keyboard 10 comprises an overlay frame 11, a multi-touch pad 12, and four independent piezo actuators 13a, 13b, 13c and 13d. The piezo actuators 13a, 13b, 13c and 13d are used for generating mechanical vibration on the surfaces of pre-defined touch pad regions corresponding to the piezo actuators 13a, 13b, 13c and 13d, respectively. The overlay frame 11 comprises plural openings 111. The overlay frame 11 is disposed over the multi-touch pad 12 for providing a tactile feedback function. When the user's fingertip is placed in an opening 111, which is equivalent to a keycap area, the position of the fingertip is detected by the multi-touch pad 12. According to a two-dimensional position of the user's fingertip, the multi-touch pad 12 generates a key signal. Moreover, the piezo actuators 13a, 13b, 13c and 13d are arranged between the overlay frame 11 and the multi-touch pad 12. In response to the key signal, a corresponding one of the piezo actuators 13a, 13b, 13c and 13d is driven to generate a feedback signal. In an embodiment, the multi-touch pad 12 of the touch keyboard 10 is a capacitive touch pad for converting the capacitance change into the two-dimensional coordinates of the fingertip position. In another embodiment, the multi-touch pad 12 of the touch keyboard 10 is a resistive touch pad for converting the electrical resistance into the two-dimensional coordinates of the fingertip position. The examples of the multi-touch pad 12 are presented herein for purpose of illustration and description only. According to the tactile sensation provided by the overlay frame 11 and the feedback signal (e.g. mechanical vibration) provided by the piezo actuators 13a, 13b, 13c and 13d, the user can sense the keystrokes of the touch keyboard 10 in order to correctly execute the typing activities.

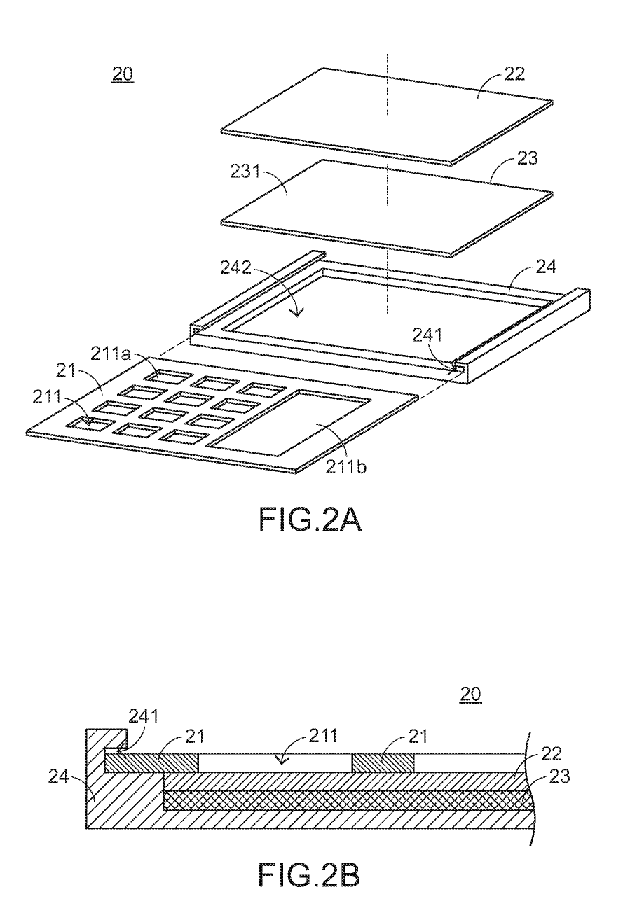

A touch keyboard according to a second embodiment of the present invention will be illustrated as follows. FIG. 2A is a schematic exploded view illustrating a touch keyboard according to a second embodiment of the present invention. FIG. 2B is a schematic cross-sectional view illustrating the touch keyboard according to the second embodiment of the present invention. As shown in FIGS. 2A and 2B, the touch keyboard 20 comprises an overlay frame 21, a touch pad 22, a feedback device 23, and a base plate 24. The overlay frame 21 is disposed over the touch pad 22 and covers the touch pad 22. The feedback device 23 is disposed under the touch pad 22. When the touch pad 22 is touched, a key signal is generated by the touch pad 22. In response to the key signal, the feedback device 23 generates a feedback signal. The feedback device 23 comprises a feedback region 231. When the feedback signal is generated by the feedback device 23, the user who touches the feedback region 231 can sense the keystrokes of the touch keyboard 20 according to the feedback signal. The base plate 24 is disposed under the touch pad 22 and the feedback device 23.

The base plate 24 comprises a sliding groove 241 and a receiving space 242. The sliding groove 241 is located at a lateral edge of the base plate 24 for accommodating the overlay frame 21. Moreover, the overlay frame 21 is slidable relative to the base plate 24. The receiving space 242 is used for accommodating the touch pad 22 and the feedback device 23. Depending on the keyboard languages, the layouts of the overlay frame 21 are different. According to the requirement of the keyboard language, the overlay frame 21 may be replaced. After the overlay frame 21 is replaced with a new one, the sequence and the number of the openings of the overlay frame 21 are changed.

In this embodiment, the overlay frame 21 is a rigid plate that is made of a non-conductive material. Moreover, the overlay frame 21 has many rectangular openings 211. Like the keycaps of the conventional keyboard, the rectangular openings 211 have the functions of guiding the user's fingers. Moreover, the sizes of the rectangular openings 211 of the overlay frame 21 may be different, but are not limited thereto. As shown in FIG. 2A, the area of the rectangular opening 211a is smaller than the area of the rectangular opening 211b. The larger rectangular opening 211b may be aligned with a numeric keypad region or a cursor controlling region of the touch keyboard 20.

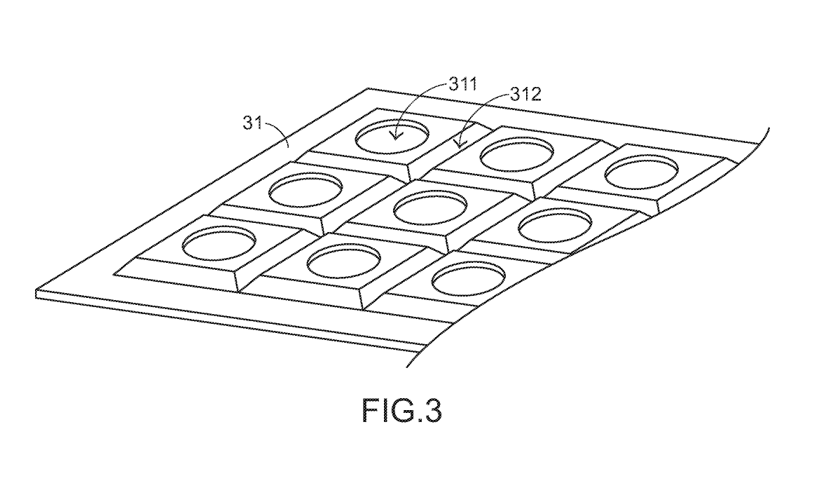

Other exemplary overlay frames of the touch keyboard of the present invention will be illustrated as follows. FIG. 3 is a schematic partial perspective view illustrating an overlay frame of a touch keyboard according to a third embodiment of the present invention. As shown in FIG. 3, the overlay frame 31 is a rigid plate with plural circular openings 311. Like the keycaps of the conventional keyboard, the circular openings 311 have the functions of guiding the user's fingers. Moreover, the overlay frame 31 has plural notches 312. Every two adjacent openings 311 are separated from each other by a notch 312. These notches 312 are collaboratively defined as plural rectangular boundaries for enclosing the openings 311. Consequently, each opening 311 and the adjacent notches 312 are equivalent to a keycap area of the conventional keyboard. The opening 311 and the adjacent notches 312 are used for providing the tactile feedback of a virtual keycap on the touch keyboard. In this embodiment, the notches 312 are V-shaped notches, but are not limited thereto.

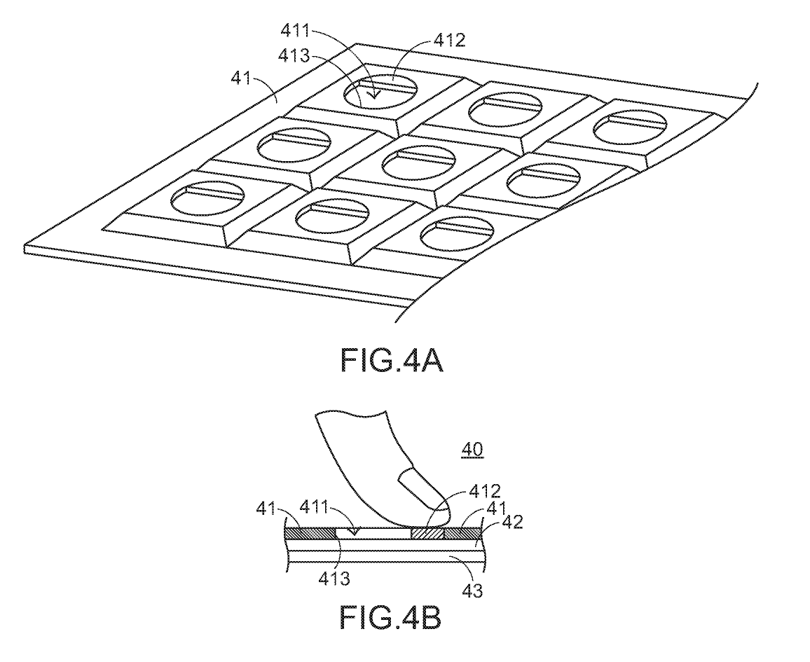

Please refer to FIGS. 4A and 4B. FIG. 4A is a schematic partial perspective view illustrating an overlay frame of a touch keyboard according to a fourth embodiment of the present invention. The overlay frame 41 comprises plural openings 411 and plural non-conductive slices 412. Each opening 411 comprises an inner wall 413. The non-conductive slice 412 is disposed on the inner wall 413 (e.g. a portion of an inner circumference of the opening 411) for resting the user's finger. In this embodiment, the non-conductive slices 412 are rigid structures, but are not limited thereto.

FIG. 4B is a schematic cross-sectional view illustrating the touch keyboard according to the fourth embodiment of the present invention. In this embodiment, the touch keyboard 40 comprises an overlay frame 41, the plural non-conductive slices 412, a touch pad 42, and a feedback device 43. The touch pad 42 is disposed under the overlay frame 41 for generating a key signal. The feedback device 43 is disposed under the touch pad 42 for generating a feedback signal.

The structures and functions of the touch pad 42 and the feedback device 43 of the touch keyboard of the fourth embodiment are similar to those of the above embodiments, and are not redundantly described herein. As shown in FIG. 4B, the touch keyboard 40 has the non-conductive slices 412 for comfortably placing and resting the user's fingers thereon. Moreover, due to the non-conductive slices 412, when the fingertip is ready to execute the typing activity, the possibility of accidentally touching the touch pad 42 to erroneously generate the key signal will be minimized.

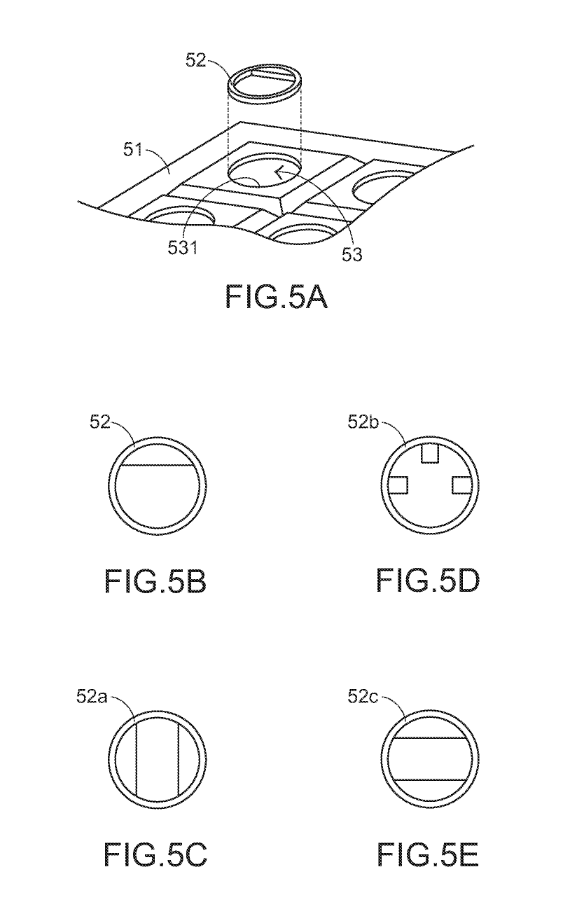

FIG. 5A is a schematic partial perspective view illustrating an overlay frame of a touch keyboard according to a fifth embodiment of the present invention. The overlay frame 51 comprises plural ring-shaped non-conductive slices 52 and plural openings 53. Each opening 53 has an inner wall 531 (e.g. an inner circumference of the opening 53). In this embodiment, the ring-shaped non-conductive slices 52 are elastic rings.

FIG. 5B is a schematic top view illustrating a ring-shaped non-conductive slice of the touch keyboard of FIG. 5A. FIGS. 5C-5E are schematic top views illustrating some variants of the ring-shaped non-conductive slice of the touch keyboard of FIG. 5A. Depending on the sizes of the user's fingers and the user's preferences, the ring-shaped non-conductive slices 52, 52a, 52b and 52c with different shapes may be selected. Moreover, these ring-shaped non-conductive slices 52, 52a, 52b and 52c may be easily replaced by any other non-conductive slices with desired shapes.

FIG. 5F is a schematic exploded view illustrating a touch keyboard according to a sixth embodiment of the present invention. As shown in FIG. 5F, the touch keyboard 60 comprises an overlay frame 61, a touch pad 62, a feedback device 63, and a non-conductive plate 64. The touch pad 62 is disposed under the overlay frame 61. The feedback device 63 is disposed under the touch pad 62.

The non-conductive plate 64 is disposed under the overlay frame 61, and arranged between the overlay frame 61 and the touch pad 62. The touch pad 62 and the feedback device 63 are covered by the non-conductive plate 64. Instead of installing the ring-shaped non-conductive slices 52 of FIG. 5A, the non-conductive plate 64 can be used to define the keycap areas of the touch keyboard. The non-conductive plate 64 comprises plural perforations 641 and plural bulges 642. Each perforation 641 has an inner wall 643. The bulge 642 is disposed on the inner wall 643 of a corresponding perforation 641 for resting the user's fingers and preventing from accidentally touching the touch pad 62. Each perforation 641 is aligned with a corresponding opening 611 of the overlay frame 61. In this embodiment, the perforations 641 and the bulges 642 of the non-conductive plate 64 are directly located under the corresponding openings 611 of the overlay frame 61, respectively.

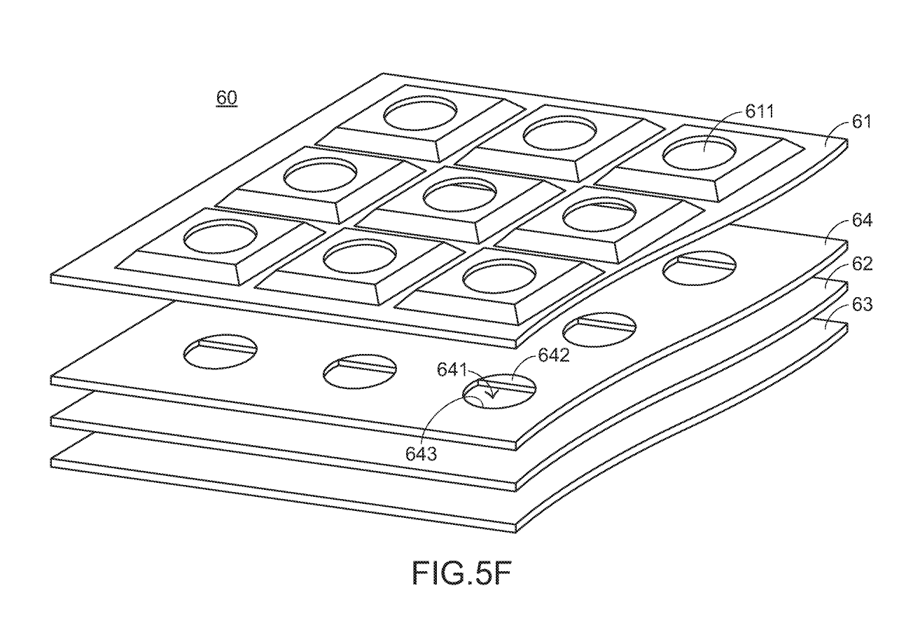

FIGS. 6A and 6B schematically illustrate the actions of a piezo actuator used in the touch keyboard of the present invention. The piezo actuator 70 may be operated in a released status A and a deformed status B. In response to a change of an electric voltage, the piezo actuator 70 is subjected to deformation, and the status of the piezo actuator 70 is changed. Consequently, the piezo actuator 70 generates vibration. The operating principles of the piezo actuator 70 are well known to those skilled in the art and widely applied to the electronic component market, and are not redundantly described herein.

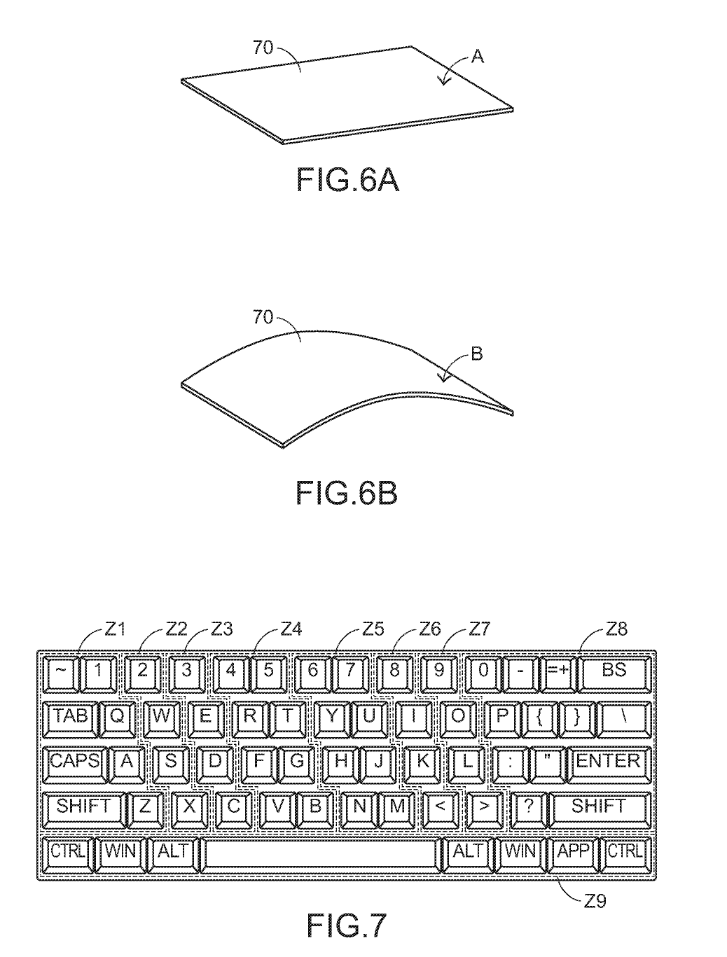

FIG. 7 schematically illustrates the layout of a US standard keyboard. According to the keycap arrangement, the US standard keyboard may be divided into nine regions Z1, Z2, Z3, Z4, Z5, Z6, Z7, Z8 and Z9 corresponding to the thumbs, the index fingers, the middle fingers, the ring fingers and the little fingers of the both hands of the user. For enhancing the identification of the keys, the positions of the touch pad or the feedback device corresponding to the key F and the key J may have distinctive surface textures in order to enhance the distinctive tactile feel. The distinctive surface textures are made of different materials or structures or covered by a special material. For example, the distinctive surface textures are salient points or friction-enhancing structures, but are not limited thereto.

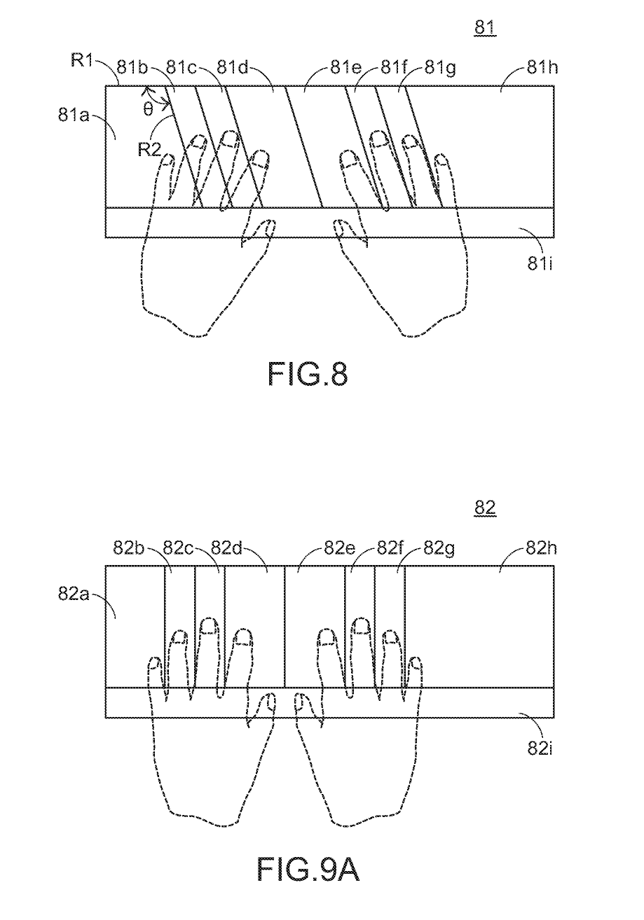

FIG. 8 is a schematic top view illustrating the feedback regions of a feedback device of a touch keyboard according to a seventh embodiment of the present invention. As shown in FIG. 8, the feedback device 81 comprises nine piezo actuators (not shown) corresponding to the feedback regions 81a, 81b, 81c, 81d, 81e, 81f, 81g, 81h and 81i in order to provide feedback signals to the feedback regions 81a, 81b, 81c, 81d, 81e, 81f, 81g, 81h and 81i, respectively. The feedback regions 81a, 81b, 81c, 81d, 81e, 81f, 81g, 81h and 81i are correlated with different fingers of the user. Each feedback region (e.g. the feedback region 81a) has a short side R1 and a long hypotenuse R2. In this embodiment, an included angle θ is formed between the short side R1 and the long hypotenuse R2. In this embodiment, the included angle θ is an obtuse angle. According to the vibration of the piezo actuator and the tap input sensitivity of the touch pad (not shown), each of the feedback regions 81a, 81b, 81c, 81d, 81e, 81f, 81g, 81h and 81i can provide vibration to the corresponding fingers (e.g. the thumbs, the index fingers, the middle fingers, the ring fingers or the little fingers).

Consequently, the touch keyboard using the feedback device 81 can provide a highly reliable user interface similar to a conventional keyboard. Since the nine piezo actuators provide different feedback signals, feedback device 81 can provide intuitive feedback for allowing the user to confirm whether the user's fingers correctly touch the keycap areas of the touch keyboard. If a resistive touch pad is selected as the touch pad of the touch keyboard, the pressure data about the user's fingers are detected by the resistive touch pad. The pressure data about the user's fingers may be used for precisely tuning the tap sensitivity of the touch keyboard and judging the user's intention of the typing activity. Alternatively, the pressure data about the user's fingers may be used to determine a threshold value of judging the user's intention of the typing activity. Moreover, the pressure data about the user's fingers may be used to discriminate whether the user tries to push the virtual key of the touch keyboard down or just keep on resting the fingers on the surface of touch pad.

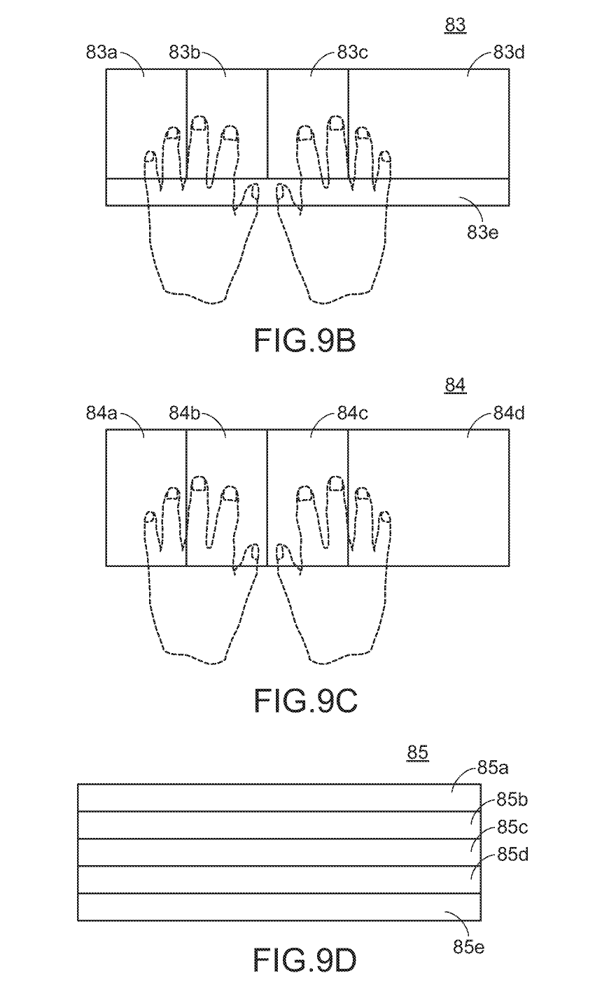

FIGS. 9A-9D are schematic top views illustrating some variants of the feedback regions of the feedback device used in the touch keyboard of the present invention. As shown in FIG. 9A, the feedback device 82 comprises nine feedback regions 82a, 82b, 82c, 82d, 82e, 82f, 82g, 82h and 82i. The layout of the nine feedback regions 82a, 82b, 82c, 82d, 82e, 82f, 82g, 82h and 82i is similar to the keycap arrangement of the US standard keyboard of FIG. 7.

FIGS. 9B and 9C are simplified versions to provide four to five independent feedback regions for generating the feedback signals. As shown in FIG. 9B, the feedback device 83 comprises five feedback regions 83a, 83b, 83c, 83d and 83e. As shown in FIG. 9C, the feedback device 84 comprises four feedback regions 84a, 84b, 84c and 84d. Moreover, the four feedback regions 84a, 84b, 84c and 84d are arranged along a vertical direction. As shown in FIG. 9D, the feedback device 85 comprises five rows of feedback regions 85a, 85b, 85c, 85d and 85e. That is, these feedback regions 85a, 85b, 85c, 85d and 85e are arranged along a horizontal direction. The optimal configuration of the feedback regions may be determined according to the usability tests, the manufacturing complexity and the cost of touch keyboard.

FIG. 9E is a schematic exploded view illustrating a touch keyboard according to an eighth embodiment of the present invention. As shown in FIG. 9E, the touch keyboard 90 comprises an overlay frame 91, a touch pad 92, and plural feedback devices 93. The feedback devices 93 are arranged between the overlay frame 91 and the touch pad 92. The feedback devices 93 have respective feedback regions 93a, 93b, 93c and 93d. These feedback regions 93a, 93b, 93c and 93d are not interfered from each other. Consequently, the feedback regions 93a, 93b, 93c and 93d may be used to generate multiple keystrokes and result in simultaneous haptic response signals. Moreover, these haptic response signals do not have to be cooperative because the typing action by each finger is always an independent input action. As shown in FIG. 9E, the touch keyboard 90 comprises four independent feedback devices 93. Each of the feedback devices 93 comprises two piezo actuators 931. These four feedback devices 93 provide vibration tactile feedback corresponding to the detection of finger touch on touch keyboard 90.

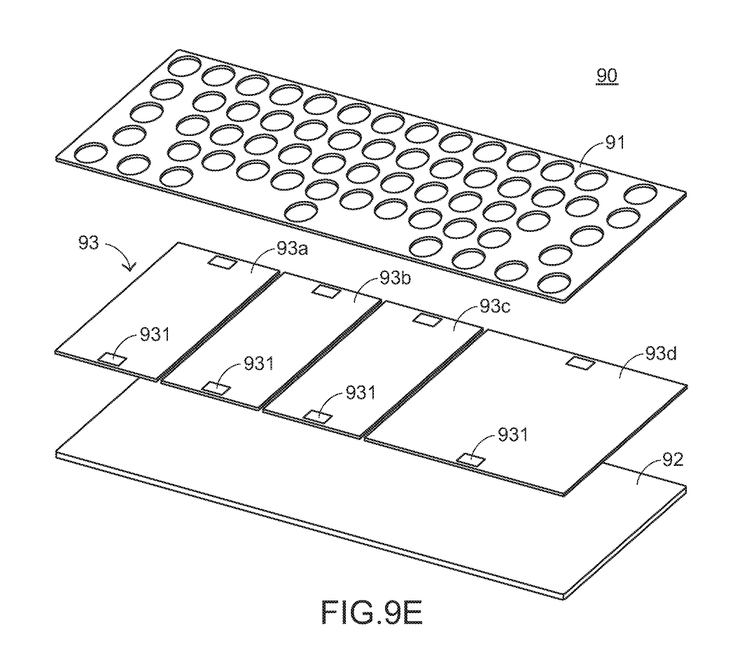

FIG. 10 is a schematic top view illustrating a touch keyboard according to a ninth embodiment of the present invention. As shown in FIG. 10, the touch keyboard 94 further comprises a speaker 95. The speaker 95 is installed on a surface of the touch keyboard 94 for generating a directive typing sound. Moreover, the speaker 95 may create different typing sounds corresponding to respective feedback regions. For example, the touch keyboard 94 has five independent feedback regions (not shown), the touch keyboard 94 can generate five different emulated key sounds. Moreover, the speaker 95 for generating the directive typing sounds is a special sound-generation device that can propagate the sound wave within a limited angle range. Consequently, only the user can hear the directive typing sound.

### Firmware Structure and Host Support Software

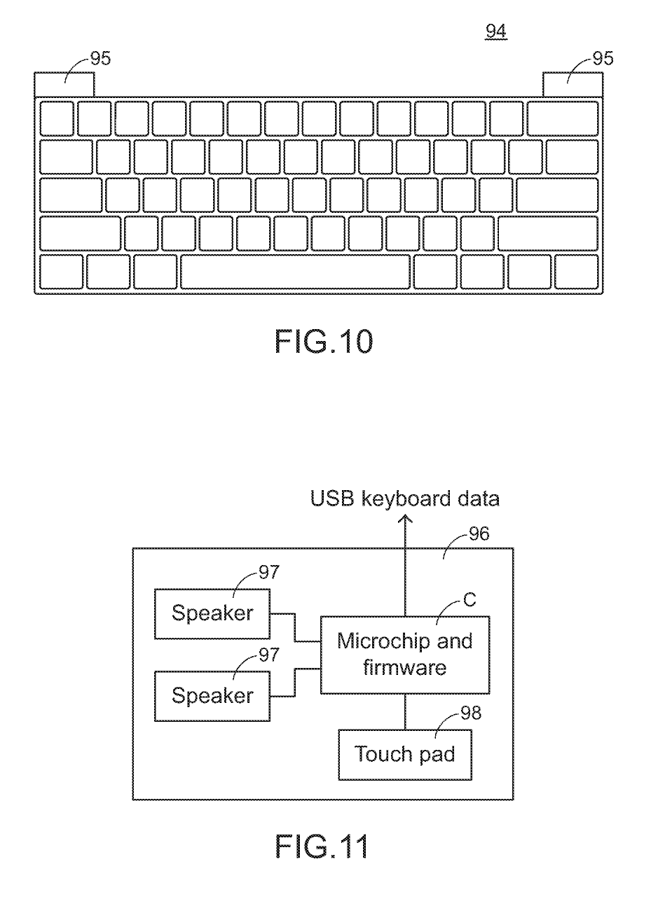

FIG. 11 is a schematic functional block illustrating a touch keyboard according to a tenth embodiment of the present invention. As shown in FIG. 11, the touch keyboard 96 comprises two directive speakers 97, a touch pad 98, and a microchip and firmware C. The directive speakers 97 are used for generating directive typing sounds. The touch pad 98 is used for sensing the user's fingers. The microchip and firmware C is used for managing the keystrokes and the feedback signals, and outputting a USB keyboard data to a tablet computer, a host computer or any other electronic device. Moreover, the firmware defines a logical device of a conventional USB keyboard. The firmware executes the following computational tasks in a real-time manner: (1) recognition of the finger touch and identification of the absolute position of the finger touch in the local two-dimensional coordinates on the touch pad 98, (2) activation of the feedback signal (e.g. the piezo vibration) corresponding to the pre-defined feedback regions of current touch, (3) activation of emulated keystroke sound corresponding to the pre-defined feedback regions of the current touch, (4) conversion of the data packets including absolute touch position into pre-defined keystroke data packets; and (5) generation of USB keyboard data packets and sending the USB keyboard data packets to the computer host.

From the above descriptions, the present invention provides a touch keyboard. The touch keyboard comprises an overlay frame, a touch pad, and a feedback device. The touch pad and the feedback device are disposed under the overlay frame. The overlay frame comprises plural openings for providing the keystrokes of the touch keyboard. When the user's finger is penetrated through a corresponding opening to touch the touch pad, the touch pad generates a key signal, and the feedback device generates a feedback signal to the user. Consequently, the touch keyboard provides a user-friendly interface. The touch keyboard of the present invention is thin and lightweight, and is easily carried. Moreover, due to the keystrokes provided by the overlay frame and the feedback device, the touch keyboard of the present invention is easily acceptable by the user. Consequently, the comfort of using the touch keyboard is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch keyboard, comprising:
an overlay frame comprising plural openings;
a touch pad disposed under said overlay frame, wherein when said touch pad is touched through one of said plural openings, said touch pad generates a key signal; and
a feedback device disposed under said overlay frame for generating a feedback signal in response to said key signal.

2. The touch keyboard according to claim 1, wherein said touch pad is disposed over said feedback device.

3. The touch keyboard according to claim 1, wherein said touch pad is disposed under said feedback device.

4. The touch keyboard according to claim 1, wherein said touch pad is a capacitive touch pad or a resistive touch pad.

5. The touch keyboard according to claim 1, wherein said feedback device is a piezo actuator.

6. The touch keyboard according to claim 5, wherein said feedback device further comprises a speaker.

7. The touch keyboard according to claim 5, wherein said feedback device comprises a feedback region.

8. The touch keyboard according to claim 5, wherein said feedback device comprises plural feedback regions.

9. The touch keyboard according to claim 8, wherein said plural feedback regions are arranged along a horizontal direction.

10. The touch keyboard according to claim 8, wherein said plural feedback regions are arranged along a vertical direction.

11. The touch keyboard according to claim 8, wherein each of said plural feedback regions has a short side and a long hypotenuse, wherein an included angle is formed between said short side and said long hypotenuse.

12. The touch keyboard according to claim 1, wherein every two openings are separated from each other by a notch.

13. The touch keyboard according to claim 1, wherein said overlay frame further comprises plural non-conductive slices, wherein each opening has an inner wall, and each of said non-conductive slices is disposed on said inner wall of said corresponding opening.

14. The touch keyboard according to claim 13, wherein said non-conductive slices are elastic rings.

15. The touch keyboard according to claim 1, wherein said touch keyboard comprises a non-conductive plate, and said non-conductive plate is disposed under said overlay frame, wherein said non-conductive plate comprises plural perforations and plural bulges, wherein each of said plural perforations has an inner wall, and each of said plural bulges is disposed on said inner wall of said corresponding perforation, wherein said plural perforations are aligned with said plural openings of said overlay frame, respectively.

16. The touch keyboard according to claim 1, wherein said overlay frame is made of a non-conductive material.

17. The touch keyboard according to claim 1, wherein said plural openings of said overlay frame are rectangular openings or circular openings.

18. The touch keyboard according to claim 1, wherein said touch keyboard further comprises a base plate, and said base plate is disposed under said touch pad and said feedback device, wherein said base plate comprises a sliding groove, and said sliding groove is disposed on a lateral edge of said base plate for accommodating said overlay frame.
